(19) United States
(12) Patent Application Publication
(10) Pub. No.: US 2023/0310263 A1
(43) Pub. Date: Oct. 5, 2023

(54) Inversion Table with Dual Massagers

(71) Applicant: Jennifer Wu, Sunnyvale, CA (US)

(72) Inventor: Jennifer Wu, Sunnyvale, CA (US)

(21) Appl. No.: 17/710,473

(22) Filed: Mar. 31, 2022

(51) Int. Cl. A61H 23/02

(52) U.S. Cl. CPC A61H 23/02; A61H 2205/081; A61H 2201/1609; A61H 2201/1647; A61H 2201/0207; A61H 2201/0138; A61H 2203/0493

(57) ABSTRACT

An inversion table having a neck massager. The neck massager includes a vibrating feature and may also include a heating feature. The neck massager may be contoured to fit a user's neck and may also include a bendable piece to allow a user to customize the shape of the neck massager. The inversion table also may have a back massager. The back massager may include a vibrating feature and a heating feature.

### FIELD OF THE INVENTION

Generally, the present invention relates to an inversion table with a dual massagers for a user's neck and back regions to provide relief and comfort.

### DESCRIPTION OF RELATED ART

Inversion tables are known for stretching the lower back and for providing temporary back pain relief. More generally, inversion therapy involves lying flat on your back at an angle or hanging upside down, in head-down position.

Current inversion tables do not provide a neck massager and back massager that have vibrating and heating features. These features can provide additional relief or comfort for a user, in addition to the other benefits of an inversion table.

Current inversion tables also do not provide a neck massager with adjustable supports to accommodate different neck sizes and shapes of various users. A user may find a neck massager to be more comfortable and more therapeutic if the user can adjust the curvature and width of the neck massager to fit the size of the specific user.

Current inversion tables also do not provide a vibrating neck massager with a heating function. A user may find additional benefits from heat therapy along with the use of the inversion table and the vibrating neck massager feature.

The present disclosures address at least some of the issues described above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The present invention provides for an inversion table that includes a neck massager and a back massager having a vibrating feature. In another embodiment, the neck massager or back massager may include a heating feature. A user may selectively turn the vibrating or heating features on or off and set the level of vibration and heat. In another embodiment, the neck massager may include adjustable neck supports to fit the unique shape of a user's neck.

### BRIEF DESCRIPTION OF THE FIGURES

The disclosed subject matter will hereafter be described with reference to the accompanying drawings, wherein like reference numerals denote like elements, and:

FIG. 1 provides a perspective view of an inversion table with a neck massager and a back massager in accordance with some embodiments of the present invention.

FIG. 2 provides a perspective view of the neck massager and back massager.

FIG. 3 provides a front view of the neck massager and back massager.

FIG. 4 provides a left-side view of the neck massager and back massager.

FIG. 5 provides a right-side view of the neck massager and back massager.

FIG. 6 provides a bottom cross-sectional view of the neck massager.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DETAILED DESCRIPTION

Although specific embodiments of the present invention will now be described with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

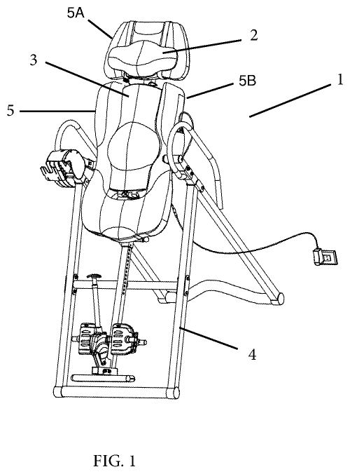

With reference to FIG. 1, an inversion table (1) is shown having a neck massager (2) and a back massager (3). The inversion table (1) has a frame (4) with a rotatable body rest (5) attached rotatably thereto. The rotatable body rest (5) can rotate with respect to the frame (4), thereby providing inversion to a user. The body rest (5) may have a separate headrest (5A) and a torso support (5B), such that the headrest (5A) supports the user's head and the torso support (5B) supports the user's torso. Alternatively, the body rest (5) may be a single piece that supports the user's head and torso (not illustrated).

The neck massager (2) is attached to the rotatable body rest (5) at the upper portion of the body rest (5) so that it will be proximate to a user's neck when the user is on the table. The back massager (3) is attached to the rotatable body rest (5) at the middle portion of the body rest (5) so that it will be proximate a user's back when the user is on the table.

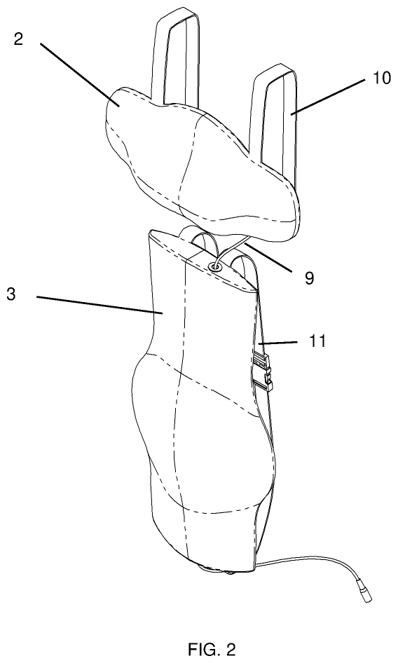

FIG. 2 illustrates a perspective view of the neck massager (2) and back massager (3). The neck massager (2) may be attached to the attached to the body rest (5) with straps (10), allowing a user to remove the neck massager (2) if desired. The straps (10) also allow a user to adjust the position of the neck massager (2) vertically along the body rest (5) to achieve better comfort. Similarly, the back massager (3) may be attached to the attached to the body rest (5) with straps (11), allowing a user to remove the back massager (3) if desired. The straps (11) also allow a user to adjust the position of the back massager (3) vertically along the body rest (5) to achieve better comfort. Electrical connections (9) may be used to connect the neck massager (2) and back massager (3) to provide power and control for the neck massager (2) and back massager (3).

FIG. 3 illustrates a front view of the vibrating neck massager (2) and back massager (3).

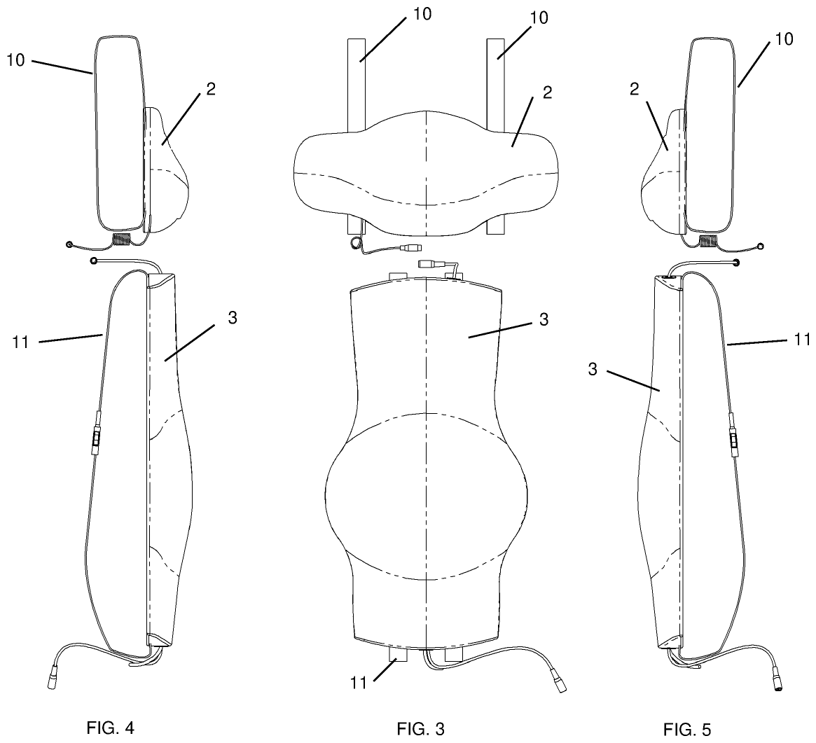

FIG. 4 illustrates a left-side view of the vibrating neck massager (2) and back massager (3).

FIG. 5 illustrates a right-side view of the vibrating neck massager (2) and back massager (3).

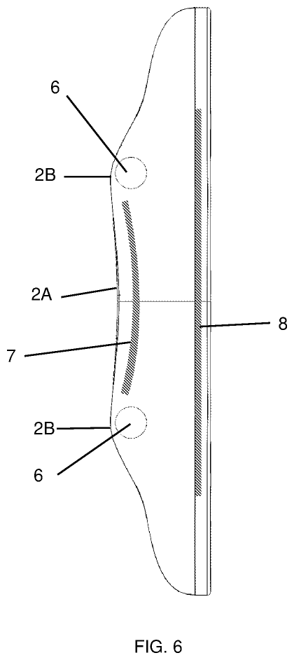

FIG. 6 illustrates a cross-sectional view of the neck massager (2). The neck massager (2) may include a middle surface (2A) and side surfaces (2B) wherein the middle surface (2A) is lower than the side surfaces (2B) in order to accommodate a user's neck. Stated differently, the middle surface (2A) may be closer to the rotatable body rest (5) than the side surfaces (2B). Alternatively, although not illustrated here, the middle surface (2A) may be at the same level as the side surfaces (2B).

Also shown in FIG. 6, the neck massager (2) includes an electric vibrating feature (6). The vibrating feature (6) may have multiple levels of vibration intensity that may be set by the user. The vibrating feature (6) may be accomplished through vibrating motors and other various ways known to those of skill in the art. Power to the vibrating feature may be provided by household electricity or a battery.

Also shown in FIG. 6, the vibrating neck massager (2) may include a heating feature (7). The heating feature (7) may be accomplished by passing electricity through heating elements and other various ways known to those of skill in the art. Power to the heating feature (7) may be provided by household electricity or a battery.

In another embodiment, the neck massager (2) may include a bendable piece (8) located within the neck massager (2) extending generally along the width of the neck massager (2). The bendable piece (8) may be made of metal of a sufficient thickness and shape that will allow the bendable piece (8) to retain its shape while also allowing a user to bend the neck massager (2) to provide a custom fit for the user's neck. Although not illustrated here, the bendable piece (8) may be rectangular in shape or ovular in shape. Although not illustrated here, the bendable piece (8) may be constructed of any material that will retain its shape while also allowing a user to bend the piece into various curves or shapes.

Although not illustrated here, the back massager may include a vibrating feature or heating feature.

The neck massager (2) and back massager (3) may be connected to a controller (not illustrated) either by a wired or wireless connection. The controller is used to turn the vibrating feature and heating feature on or off in the neck massager (2) and back massager (3). The controller may also be used to set the degree of vibration and heat in the neck massager (2) and back massager (3).

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

What is claimed is:

1. An inversion therapy table comprising:
a frame,
a body rest rotatably connected to the frame, the body rest comprising
an upper portion and a middle portion, wherein the upper portion is proximate a user's head and the middle portion is proximate a user's back,
a neck massager attached to the upper portion of the body rest proximate a user's neck,
the neck massager comprising
an electric vibrating feature.

2. The inversion table of claim 1, wherein
the vibrating feature is comprised of one or more electric motors.

3. The inversion table of claim 1, wherein
the neck massager has a heating feature.

4. The inversion table of claim 3, wherein
the heating feature is comprised of electric heating elements.

5. The inversion table of claim 1, wherein
the neck massager includes a bendable piece that extends generally along the width of the neck massager.

6. The inversion table of claim 5, wherein
the bendable piece is made of metal.

7. The inversion table of claim 1, wherein
the neck massager comprises a middle surface and side surfaces such that the middle surface is closer to the upper portion of the rotatable body rest than the side surfaces.

8. The inversion table of claim 1, further comprising
a back massager located in the middle portion of the body rest, the back massager comprising
an electric vibrating feature.

9. The inversion table of claim 8, wherein
the vibrating feature of the back massager is comprised of one or more electric motors.

10. The inversion table of claim 8, wherein
the back massager has a heating feature.

11. The inversion table of claim 10, wherein
the heating feature of the back massager is comprised of electric heating elements.

12. A neck massager for an inversion therapy table, the neck massager comprising
an electric vibrating feature.

13. The neck massager of claim 12, wherein
the vibrating feature is comprised of one or more electric motors.

14. The neck massager of claim 12, wherein
the neck massager has a heating feature.

15. The neck massager of claim 14, wherein
the heating feature is comprised of electric heating elements.

16. The neck massager of claim 12, wherein
the neck massager includes a bendable piece that extends generally along the width of the neck massager.

17. The neck massager of claim 16, wherein
the bendable piece is made of metal.

18. The neck massager of claim 1, wherein
the neck massager comprises a middle surface, side surfaces, and a rear surface such that the middle surface is closer to the rear surface than the side surfaces.
